(19) United States
(12) Patent Application Publication
(10) Pub. No.: US 2009/0101426 A1
(43) Pub. Date: Apr. 23, 2009

(54) Vehicle

(75) Inventors: John Vonli, Laksevag (NO); Nere G. Skomedal, Sogne (NO); Thomas Kjaer, Mandal (NO); Jon Taby, Gressvik (NO); John Gifford, Whitnap (GB); Kristian Mellingen, Kristiansand (NO); Arve Pedersen, Sogne (NO); John Tondevoldshagen, Mandal (NO); Magnus Tvete, Trondheim (NO); Egil Jullumsto, Hommelvik (NO); Trond Sneve, Sogne (NO); Roy Isaksen, Soreidgrend (NO); Anders Hjelmseth, Sogne (NO); John Stenberg, Porsgrunn (NO); Tor Stokke, Tveit (NO)

Correspondence Address: CHRISTIAN D. ABEL, ONSAGERS AS, POSTBOKS 6963 ST. OLAVS PLASS, NORWAY, N-0130, NO

(73) Assignee: UMOE MANDAL AS, Mandal (NO)

(21) Appl. No.: 11/873,433

(22) Filed: Oct. 17, 2007

(51) Int. Cl. B60V 1/00

(52) U.S. Cl. 180/116

(57) ABSTRACT

Vehicle for operation on various grounds, including a hull (1) having a first sidehull (10) and a second sidehull (12), a front skirt device (14), a stern skirt device (16), and side skirt devices (18) having side skirt elements (54) movably fastened to the hull (1) by means of a platform arrangement (20) between a first position and a second position.

### FIELD OF THE INVENTION

The present invention relates to a vehicle for operation on various grounds.

### BACKGROUND OF THE INVENTION

Several types of so-called Tri-Modal sea-to-shore-transporting vehicles are shown one page 36-38 in the September 2007 issue of the digital magazine Seapower (http://www.seapower-digital.com/seapower/200709/).

The purpose of these vehicles is to transport heavy wheeled and tracked vehicles from a sea base to an unprepared shore. There are several requirements for such vehicles, for example should the vehicle be able to travel on sea at large speed over long distances, and also to be able to travel on various grounds, such as shallow water, sandbars, mudflats, beaches, sumps etc to unload their load as far as possible, preferably on dry land.

The object of the present invention is to provide a vehicle suitable for these requirements.

### SUMMARY OF THE INVENTION

The present invention relates to a vehicle for operation on various grounds, comprising:
a hull comprising a first sidehull and a second sidehull;
a front skirt device;
a stern skirt device;
side skirt devices comprising side skirt elements movably fastened to the hull by means of a platform arrangement between a first position and a second position.

In an aspect of the invention, the front skirt device is movable between a first position and a second position.

In an aspect of the invention, the stern skirt device is movable between a first position and a second position.

In an aspect of the invention, a first buoyancy area is defined by said first and second sidehull, said stern skirt device and said front skirt device in their respective first positions.

In an aspect of the invention, a second buoyancy area is defined by said front skirt device, said stern skirt device and said side skirt devices in their respective second positions.

In an aspect of the invention, the side skirt elements are rotatable about a rotation axis.

In an aspect of the invention, the platform arrangement comprises hinges for rotating the side skirts in relation to the hull.

In an aspect of the invention, the side skirt elements are inflated in their second position.

### BRIEF DESCRIPTION OF THE DRAWINGS

It is now referred to the enclosed drawings, where preferred embodiments of the invention are illustrated in detail.

FIGS. 1a and 1b illustrates a side view of the vehicle in SES mode and ACV mode respectively.

FIG. 2 illustrates a perspective bottom view of an embodiment in SES mode.

FIG. 3 illustrates a perspective bottom view of the embodiment in FIG. 2 in ACV mode.

FIG. 4 illustrates the positions of the side skirts and stern skirt in SES mode.

FIG. 5 illustrates the positions of the side skirts and front skirt in ACV mode.

FIG. 6 illustrates a cross sectional view of the side skirt in both SES mode and ACV mode.

FIGS. 7a and 7b illustrate the front skirt in SES mode and ACV mode respectively,

FIGS. 8a and 8b illustrates the stern skirt in SES mode and ACV mode respectively.

### DETAILED DESCRIPTION

First some expressions commonly used within the present area of technology will be described. A SES (Surface Effect Ship) is normally referred to as a vessel that has both an air cushion, like a hovercraft, and twin hulls, like a catamaran. An ACV is normally used as an abbreviation for air cushion vehicle.

In the following, the term “SES mode” will be used for a mode where the vehicle is adapted for travel on sea at large speed over long distances.

Moreover, the term “ACV mode” will be used for a mode where the vehicle is adapted for travel on various grounds, such as shallow water, mudflats, sandbars, beaches, sumps etc to unload their load as far as possible on those various grounds.

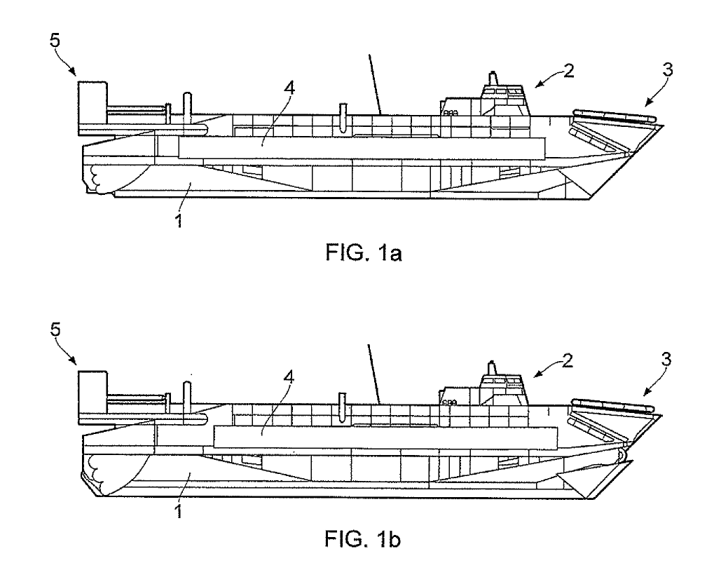

It is now referred to FIGS. 1a and 1b illustrating an embodiment of the vehicle according to the invention. Here, the vehicle is in SES mode. As seen, the vehicle comprises a hull 1, a wheel house 2, a loading/unloading opening 3 to a cargo deck 4 and propulsion means in the form of air propellers 5. Some of these elements will not be described in detail herein, as such elements are considered to be familiar for a man skilled in the art.

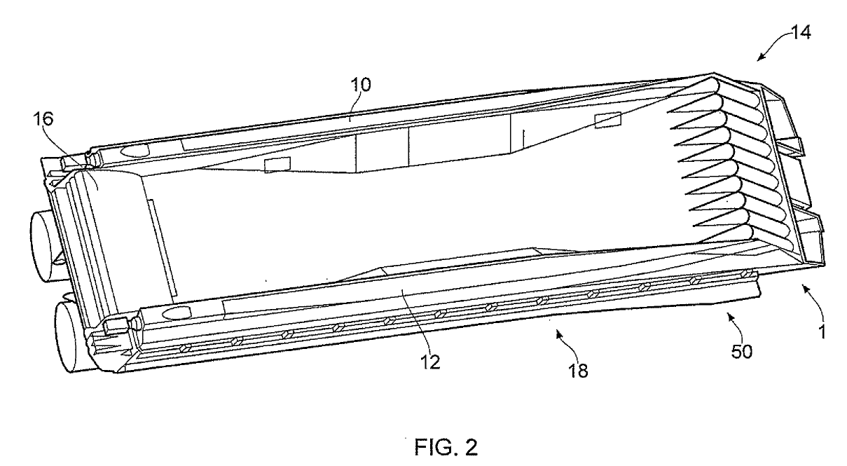

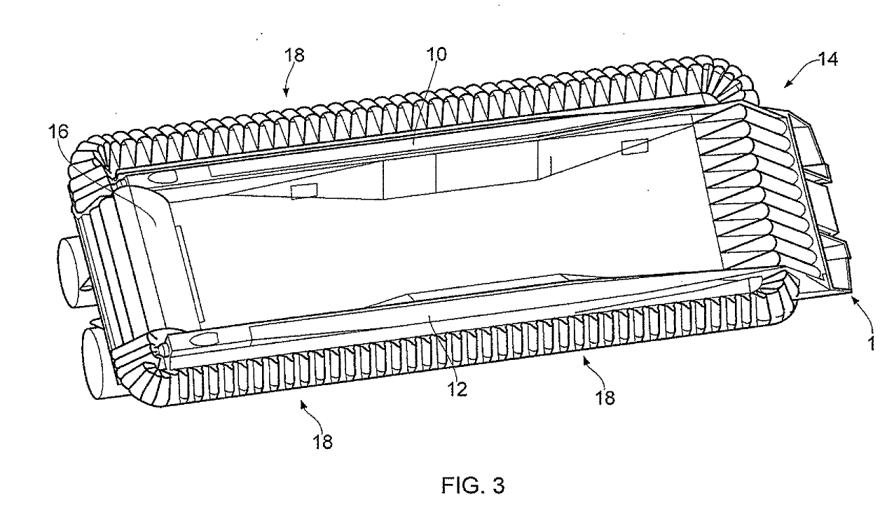

It is now referred to FIGS. 2 and 3, illustrating the bottom side of the vehicle. The hull 1 comprises a first keel or sidehull 10 and a second keel or sidehull 12, where a space is defined between the first sidehull 10 and the second sidehull 12.

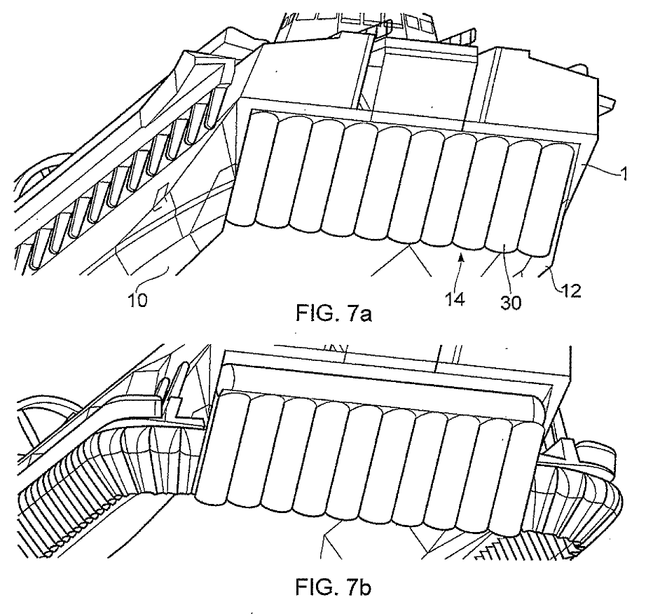

The vehicle further comprises a front skirt device 14 on the front side of the vehicle (to the right in FIG. 2), between the first and second sidehulls 10, 12, as illustrated in FIG. 2 and FIG. 7a. The front skirt device 14 comprises several finger type front skirt elements 30 and an elevation device (not shown) for raising or lowering the front skirt device vertically in relation to the hull 1 between a first, upper position and a second, lower position.

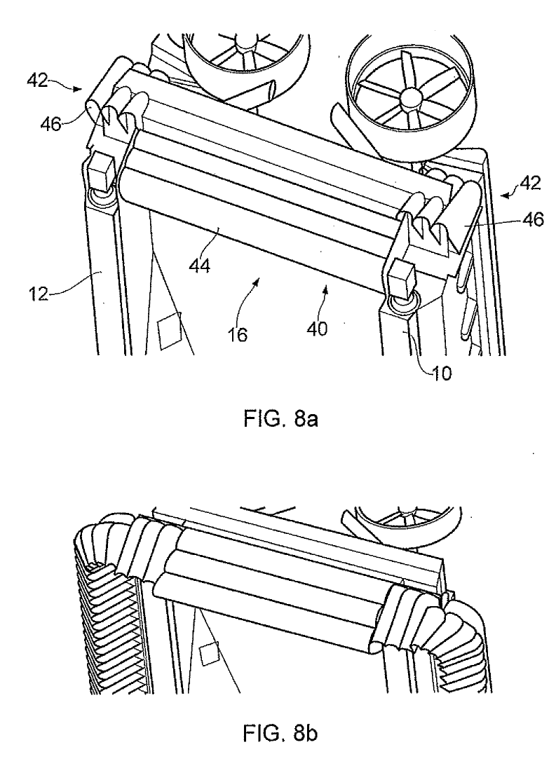

The vehicle further comprises a stern skirt device 16 on the rear side of the vehicle (to the left in FIG. 2). The stern skirt device 16 comprises a looped central stern bag skirt 40 located between the first and second sidehulls 10, 12, as illustrated in FIG. 2 and FIG. 8a. The stern skirt device 16 further comprises rear corner skirts 42 located aft of the sidehulls 10, 12.

The central stern skirt 40 comprises several pressurized loop bag elements 44. The rear corner skirts 42 comprise several semi-closed finger type skirt elements 46. Elevation devices (not shown) are provided for raising or lowering the central stern skirt device 40 and the rear corner skirts 42 respectively, vertically in relation to the hull 1 between a first, upper position and a second, lower position.

It should be noted that the central stern skirt 40 is lowered by inflating the loop bag elements 44 and raised by deflating loop bag elements 44, as illustrated in FIG. 8a and FIG. 8b. Alternatively, the central stern skirt 40 can be lowered or raised by means of a separate elevation device.

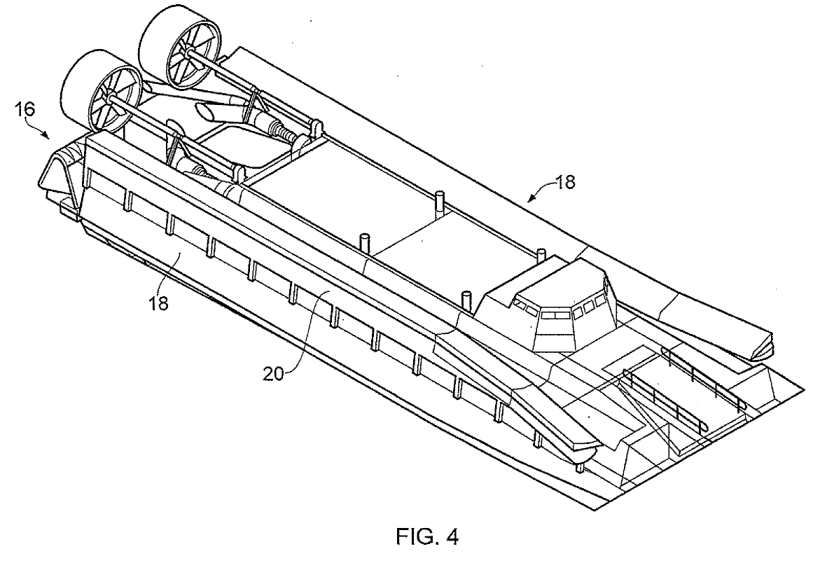

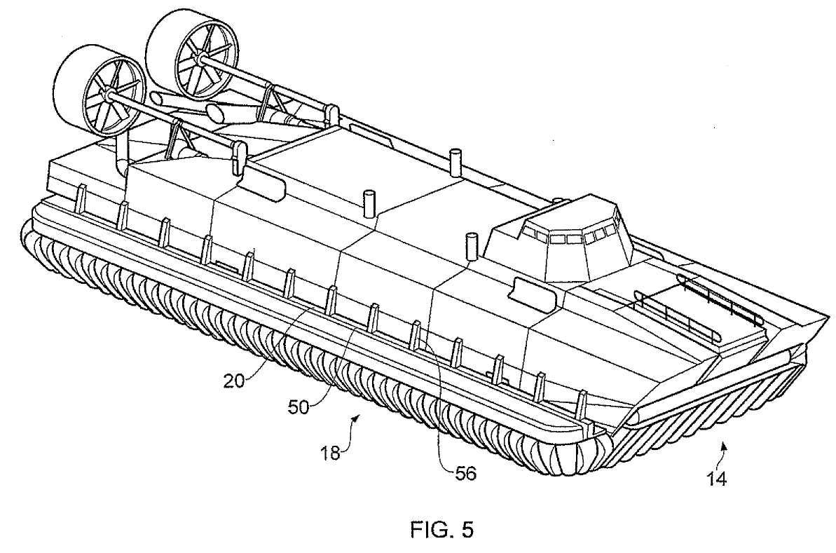

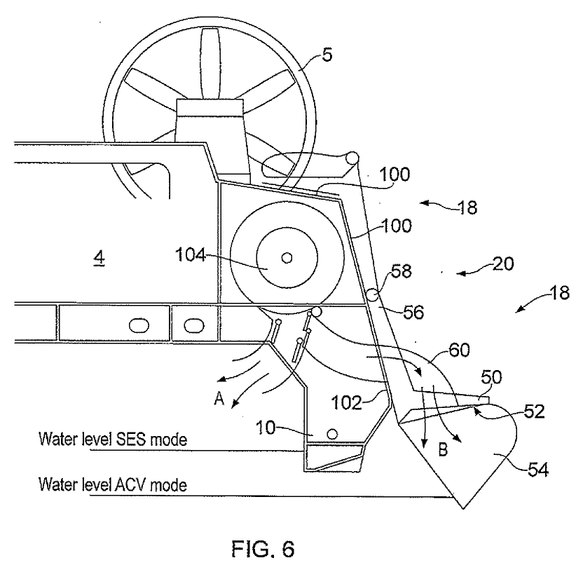

The vehicle further comprises side skirt devices 18 on the respective sides of the vehicle. Each side skirt device 18 is movably fastened to the hull by means of a platform arrangement 20 (see FIGS. 4, 5 and 6). The platform arrangement 20 comprises a substantially horizontal platform 50 having a supporting surface 52 for supporting finger type side skirt elements 54. The platform arrangement further comprises supporting rods 56 fixed to the platform 50. In their end, the supporting rods 56 comprise a rotatable connection 58, for example a hinge connection, for connection of the platform arrangement 20 to the hull 1. In this way, the side skirt device 18 can be rotatable about a rotation axis defined by said rotatable connection 58 between a first and upper position shown in FIG. 4 and a second and lower position shown in FIG. 5. Both positions are shown in FIG. 6.

Moreover, the supporting device 20 comprises an inflatable air channel 60 for longitudinal air distribution to the side skirt elements, which will be described further below.

It is now referred to FIG. 6. When the side skirt device 18 is in its first, upper position, the platform 50 and the supporting rods 56 are brought to rest towards upper supporting surfaces 100 of the hull 1.

When the front skirt device 14, the stern skirt device 16 and the side skirt devices 18 are in their respective first or upper positions, the vehicle are in the so-called SES mode. Here, a first buoyancy area is defined as the area enclosed by the lower end of said first and second sidehull 10, 12, said stern skirt device 14 and said front skirt device 16. Here, a fan 104 is blowing air from the outside into the first buoyancy area as indicated by arrows A for lifting the vehicle up from the water to decrease the water resistance of the vehicle in the water. The water level in SES mode is indicated in FIG. 6.

It should be noted that the side skirt elements of the side skirt devices in SES mode are deflated.

In SES mode, the vehicle can be propelled by means of water jets located in the rear end of sidehulls 10, 12.

When the side skirt device 18 is in its second, lower position, the supporting rods 56 are brought to rest towards lower supporting surfaces 102 of the hull 1.

When the front skirt device 14, the stern skirt device 16 and the side skirt devices 18 are in their respective second or lower positions, the vehicle are in the so-called ACV mode. Here, a second buoyancy area is defined as the area enclosed by the lower end of said front skirt device 14, said stern skirt device 16 and said side skirt device 18. In FIGS. 2 and 3 it can be seen that the second buoyancy area is larger than the first buoyancy area.

A fan 104 is blowing air from the outside to the second buoyancy area as indicated by arrows A. Moreover, the air channel 60 from fan 104 to the side skirt elements 54 of the side skirt device 18 is opened and consequently these are inflated, as indicated by arrows B. Consequently, the vehicle lifted up from the ground (water or other type of various grounds). The water level in ACV mode is indicated in FIG. 6.

It should be noted that the water level in SES and ACV mode in FIG. 6 only are meant as indications—these levels will of course vary depending on fan power, vehicle load etc.

In ACV mode, the water jets are above the water surface, consequently the vehicle here is propelled by means of the air propellers 5 on top of the vehicle.

It should be noted that the side skirt devices 18 comprises actuators, for example hydraulically, electrically or pneumatically operated actuators (not shown) to move the side skirt devices between their respective first and second positions (or, by using the above terminology, to bring the side skirt devices to rest towards the hull 1).

Also the front skirt device 14 and the stern skirt device 16 may comprise such actuators.

The vehicle may also comprise systems for inflating/deflating the skirt devices 14, 16, 18 by means of fans, air channels, valves etc.

The operation of the skirts 14, 16, 18 by means of actuators and/or inflation/deflation etc can be performed by means of control means in said wheel house for transition the vehicle between SES mode and ACV mode and vice versa. Moreover, the transition between the SES mode and ACV mode can be performed automatically, based on measurements from dept sensors etc. The transition could be performed while the vehicle is on its way or at rest.

The materials used in the skirt devices are typically reinforced rubber type materials, such as natural rubber or neoprene or similar. The reinforcement can be made of polymer fibers or other types of reinforcing fibers used for reinforcing rubber materials in tyres, transport devices etc.

The materials used in the platform device are lightweight materials, such as composites or light weight metals such as aluminum.

The sidehulls and hull are made of composite materials or aluminum or other suitable materials or combinations thereof.

Further modifications and variations will be obvious for a skilled man when reading the description above. The scope of the invention will appear from the following claims and their equivalents.

1. Vehicle for operation on various grounds, comprising:
a hull (1) comprising a first sidehull (10) and a second sidehull (12);
a front skirt device (14);
a stern skirt device (16);
side skirt devices (18) comprising side skirt elements (54) movably fastened to the hull (1) by means of a platform arrangement (20) between a first position and a second position.

2. Vehicle according to claim 1, wherein the front skirt device (14) is movable between a first position and a second position.

3. Vehicle according to claim 1, wherein the stern skirt device (16) is movable between a first position and a second position.

4. Vehicle according to claim 1, wherein a first buoyancy area is defined by said first and second sidehull (10, 12), said stern skirt device (14) and said front skirt device (16) in their respective first positions.

5. Vehicle according to claim 1, wherein a second buoyancy area is defined by said front skirt device (14), said stern skirt device (16) and said side skirt devices (18) in their respective second positions.

6. Vehicle according to claim 1, wherein the side skirt elements (54) are rotatable about a rotation axis.

7. Vehicle according to claim 1, wherein the platform arrangement (20) comprises hinges for rotating the side skirts in relation to the hull (1).

8. Vehicle according to claim 1, wherein the side skirt elements (54) are inflated in their second position.
